(19) United States
(12) Patent Application Publication
(10) Pub. No.: US 2014/0163918 A1
(43) Pub. Date: Jun. 12, 2014

(54) FAN MODULE TEST SYSTEM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: KANG-BIN WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/972,214

(22) Filed: Aug. 21, 2013

(30) Foreign Application Priority Data
Dec. 7, 2012 (CN) 2012105214826

(51) Int. Cl. G01P 5/00

(52) U.S. Cl. CPC G01P 5/00
USPC 702/113

(57) ABSTRACT

A fan module test system includes a control device, a switch unit, a wind speed sensor, and a micro control unit. The control device outputs test instructions. The switch unit receives the test instructions, and controls a fan to rotate at a rotational speed according to the test instructions. The wind speed sensor detects a wind speed. The switch unit collects rotational speed signals and wind speed signals. The micro control unit receives the rotational speed signals and the wind speed signals, and transmits the rotational speed signals and the wind speed signals to the control device. The control device determines whether the fan meets heat dissipation requirements according to the rotational speed signals and the wind speed signals.

### BACKGROUND

1. Technical Field

The present disclosure relates to a fan module test system.

2. Description of Related Art

A plurality of fans may be installed in a computer server for dissipating heat. However, the plurality of fans sometimes may not satisfy the need of heat dissipation when a number of the fans is insufficient or rotating speeds of the fans are low. On the other hand, the plurality of fans may consume excessive power and generate high noise when the number of the fans is large or rotating speeds of the fans are high.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is block diagram of an embodiment of a fan module test system.

FIG. 2 is a flow chart of a method for testing a fan module using the system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

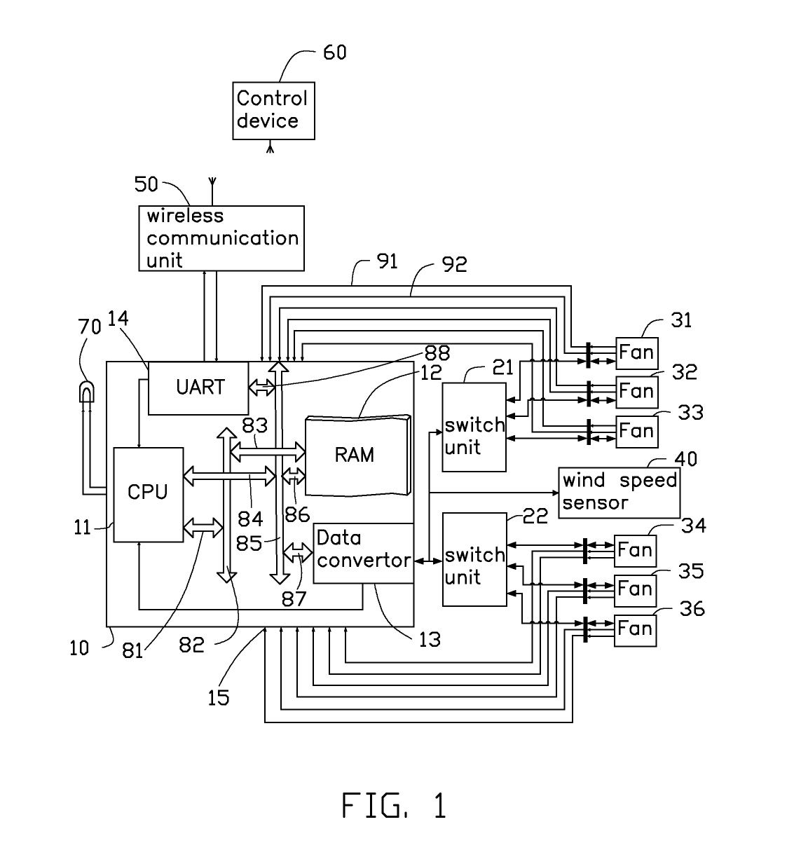

FIG. 1 shows a fan module test system of the embodiment. The fan module test system includes a micro control unit 10, two switch units 21, 22, a plurality of fans 31-36, a wind speed sensor 40, a wireless communication unit 50, a control device 60, and an indication unit 70.

The micro control unit 10 includes a central processing unit (CPU) 11, a random access memory (RAM) 12, a data convertor 13, and a Universal Asynchronous Receiver/Transmitter (UART) 14. The control device 60 transmits test instructions to the UART 14 via the wireless communication unit 50. The test instructions include pulse width modulation (PWM) signals for controlling rotational speed of fan and fan selection signals for selecting number of fan. The UART 14 transmits the test instructions to the CPU 11. The CPU 11 transmits the test instructions to the switch units 21, 22 via the data convertor 13. The switch units 21, 22 controls the corresponding fans 31-36 to rotate at a rotational speed according to the test instructions. The wind speed sensor 40 detects a wind speed at a position beside the corresponding fan. The switch units 21, 22 collect rotational speed signals and wind speed signals of the corresponding fans 31-36. The switch units 21, 22 transmit the rotational speed signals and the wind speed signals to the CPU 11 via the data convertor 13. The CPU 11 stores the rotational speed signals and the wind speed signals at a plurality of addresses in the RAM 12 via a plurality of address buses 81-83 and a plurality of data buses 84-86.

The control device 60 outputs control signals to the UART 14 via the wireless communication unit 50. The UART 14 transmits the control signals to the CPU 11. The CPU 11 reads and stores the rotational speed signals and the wind speed signals at the corresponding addresses in the RAM 12 according to the control signals. The RAM 12 transmits the rotational speed signals and the wind speed signals of the corresponding fans 31-36 to the UART 14 via data buses 85, 86, and 88. The UART 14 transmits the rotational speed signals and the wind speed signals to the control device 60 via the wireless communication unit 50. In one embodiment, the control device 60 is a computer. Each of the plurality of fans 31-36 are electrically connected to two detecting signal receiving terminals 15 of the micro control unit 10 via a first transmission line 91 and a second transmission line 92. When the plurality of fans 31-36 are electrically connected to the fan module test system, the corresponding fans 31-36 output low voltage level detecting signals to the detecting signal receiving terminals 15 via the first transmission line 91. When the plurality of fans 31-36 are not electrically connected to the fan module test system or malfunction, the corresponding fans 31-36 output high voltage level detecting signals to the detecting signal receiving terminals 15 via the second transmission line 92, the CPU 11 controls the indication unit 70 to emit light for warning.

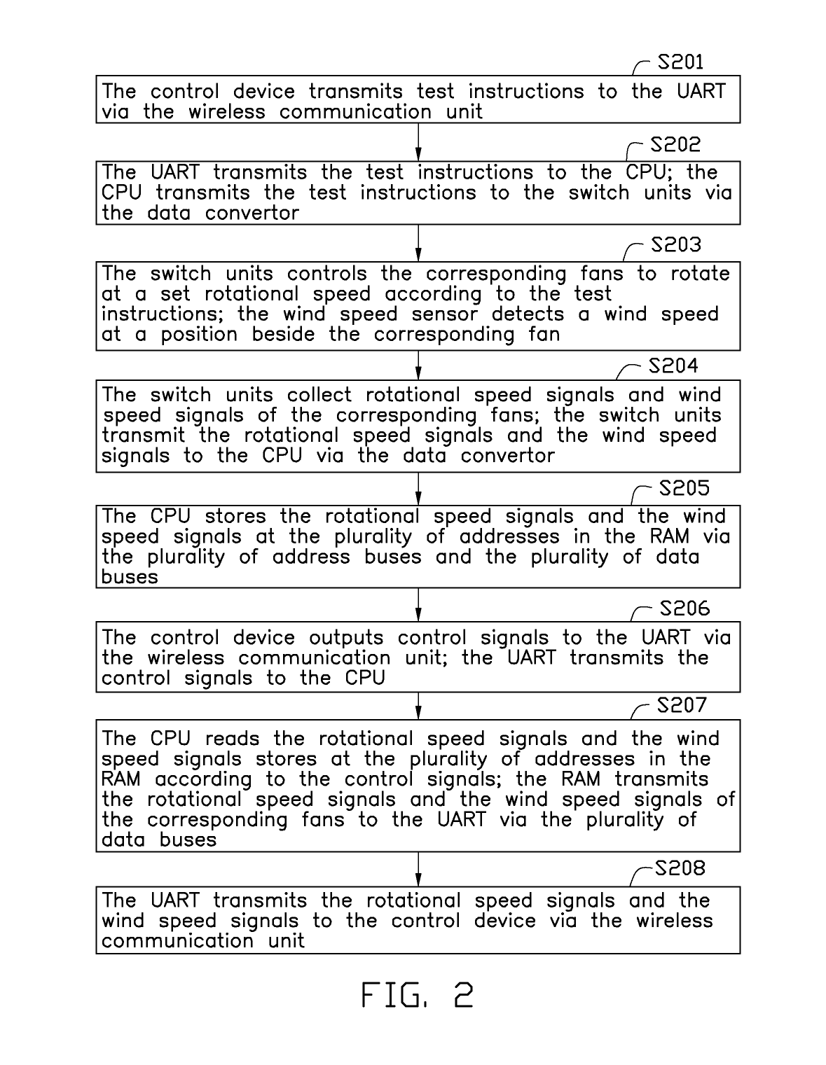

FIG. 2 shows a flow chart of an embodiment of a method for testing the plurality of fans 31-36 using the fan module test system, in accordance with one embodiment. Depending on the embodiment, certain steps described below may be removed, while others may be added, and the sequence of the steps may be altered. In one embodiment, the method for autonomous monitoring utilizing the above-described system includes the following steps:

S201: the control device 60 transmits test instructions to the UART 14 via the wireless communication unit 50;

S202: the UART 14 transmits the test instructions to the CPU 11; the CPU 11 transmits the test instructions to the switch units 21, 22 via the data convertor 13;

S203: the switch units 21, 22 controls the corresponding fans 31-36 to rotate at a set rotational speed according to the test instructions; the wind speed sensor 40 detects a wind speed at a position beside the corresponding fan;

S204: the switch units 21, 22 collect rotational speed signals and wind speed signals of the corresponding fans 31-36; the switch units 21, 22 transmit the rotational speed signals and the wind speed signals to the CPU 11 via the data convertor 13;

S205: the CPU 11 stores the rotational speed signals and the wind speed signals at the plurality of addresses in the RAM 12 via the plurality of address buses 81-83 and the plurality of data buses 84-86;

S206: the control device 60 outputs control signals to the UART 14 via the wireless communication unit 50; the UART 14 transmits the control signals to the CPU 11;

S207: the CPU 11 reads the rotational speed signals and the wind speed signals stores at the plurality of addresses in the RAM 12 according to the control signals; the RAM 12 transmits the rotational speed signals and the wind speed signals of the corresponding fans 31-36 to the UART 14 via the plurality of data buses 85, 86, and 88;

S208: the UART 14 transmits the rotational speed signals and the wind speed signals to the control device 60 via the wireless communication unit 50.

In operation, the control device 60 transmits test instructions to control the fans 31, 32 to rotate at half speed. For example, when a duty cycle of the PWM signal is 50 percent, the rotational speed of the fans 31, 32 is 50 percent of the full speed. When a duty cycle of the PWM signal is 75 percent, the rotational speed of the fans 31, 32 is 75 percent of the full speed. The wind speed sensor 40 detects a wind speed beside the fans 31, 32, and transmits the wind speed signals to the control device 60 via the micro control unit 10. The control device 60 determines whether a temperature beside the fans 31, 32 exceeds a normal temperature. Therefore, the control device 60 can determine how many fans are needed and rotational speed of the fans to meet heat dissipation requirements.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A fan module test system, comprising:
a control device adapted to output test instructions;
a switch unit adapted to receive the test instructions, and control a fan to rotate at a rotational speed according to the test instructions;
a wind speed sensor adapted to detect a wind speed; wherein the switch unit is adapted to collect rotational speed signals and wind speed signals; and
a micro control unit adapted to receive the rotational speed signals and the wind speed signals, and transmit the rotational speed signals and the wind speed signals to the control device; and the control device determines whether the fan meets heat dissipation requirements according to the rotational speed signals and the wind speed signals.

2. The fan module test system of claim 1, further comprising a wireless communication unit; the micro control unit comprises a Universal Asynchronous Receiver/Transmitter (UART); and the control device transmits the test instructions to the UART via the wireless communication unit.

3. The fan module test system of claim 2, wherein the micro control unit further comprises a central processing unit (CPU) and a data convertor; the UART transmits the test instructions to the CPU; and the CPU transmits the test instructions to the switch unit via the data convertor.

4. The fan module test system of claim 3, wherein the micro control unit further comprises a random access memory (RAM); the switch unit transmits the rotational speed signals and the wind speed signals to the CPU via the data convertor; and the CPU stores the rotational speed signals and the wind speed signals at a plurality of addresses in the RAM via a plurality of address buses and a plurality of data buses.

5. The fan module test system of claim 4, wherein the control device outputs control signals to the UART via the wireless communication unit; the UART transmits the control signals to the CPU; the CPU reads the rotational speed signals and the wind speed signals stores at the plurality of addresses in the RAM according to the control signals; the RAM transmits the rotational speed signals and the wind speed signals to the UART via the data buses; and the UART transmits the rotational speed signals and the wind speed signals to the control device via the wireless communication unit.

6. The fan module test system of claim 2, further comprising an indication unit; the fan is electrically connected to two detecting signal receiving terminals of the micro control unit via a first transmission line and a second transmission line; the detecting signal receiving terminal receives a high voltage level detecting signal from the fan via the second transmission line when the fan is not electrically connected to the fan module test system, and the CPU controls the indication unit to emit light and to indicate the fan is malfunctioning.

7. The fan module test system of claim 6, wherein the detecting signal receiving terminal receives a low voltage level detecting signal from the fan via the first transmission line to indicate that the fan is electrically connected to the fan module test system.

8. The fan module test system of claim 1, wherein the test instructions comprise pulse width modulation (PWM) signals for controlling rotational speed of fan and fan selection signals for selecting number of fan.

9. A method for testing a fan module, the method comprising:
transmitting test instructions to a Universal Asynchronous Receiver/Transmitter (UART) by a control device via a wireless communication unit;
transmitting the test instructions to a central processing unit (CPU) by the UART; the CPU transmits the test instructions to a switch unit via a data convertor; the switch unit controls the fan to rotate at a rotational speed according to the test instructions;
detecting a wind speed by a wind speed sensor;
collecting rotational speed signals and wind speed signals, and transmitting the rotational speed signals and the wind speed signals to the CPU via the data convertor by the switch unit;
storing the rotational speed signals and the wind speed signals at a plurality of addresses in a random access memory (RAM) via a plurality of address buses and a plurality of data buses by the CPU;
outputting outputs control signals to the UART by the control device via the wireless communication unit; the UART transmits the control signals to the CPU;
reading the rotational speed signals and the wind speed signals stored at the plurality of addresses in the RAM according to the control signals by the CPU; the RAM transmits the rotational speed signals and the wind speed signals to the UART via the data buses;
transmitting the rotational speed signals and the wind speed signals to the control device by the UART via the wireless communication unit; and
determining whether the fan meets heat dissipation requirements according to the rotational speed signals and the wind speed signals.
